(19) United States
(12) Patent Application Publication
(10) Pub. No.: US 2007/0221021 A1
(43) Pub. Date: Sep. 27, 2007

(54) WORKPIECE HOLDER FOR A LATHE

(76) Inventor: Eugene D. Perry, Mooresville, IN (US)

Correspondence Address: BARNES & THORNBURG LLP, 11 SOUTH MERIDIAN, INDIANAPOLIS, IN, 46204, US

(21) Appl. No.: 11/681,853

(22) Filed: Mar. 5, 2007

Related U.S. Application Data
(60) Provisional application No. 60/743,434, filed on Mar. 8, 2006.

(51) Int. Cl. B23B 33/00

(52) U.S. Cl. 82/165

(57) ABSTRACT

A workpiece holder for a lathe includes a receptacle having a workpiece-receiving-cavity that has a polygonal cross-section when viewed along an axis of rotation. The receptacle is sized to receive workpiece stock having a polygonal cross-section.

This application claims priority under 35 U.S.C. § 119(e) to U.S. Provisional Application Ser. No. 60/743,434, filed Mar. 8, 2006, which is expressly incorporated by reference herein.

### BACKGROUND OF THE INVENTION

The current disclosure relates to a holder for a workpiece which rotates while being worked upon. More specifically, the present disclosure relates to a workpiece holder for holding a piece of stock which has a non-circular cross-section while the stock is rotated by a lathe.

Various workpiece holders for use with a lathe are known. In most cases, the workpiece holder engages the end of the workpiece and includes a tapered portion which is received in a chuck of the lathe. In some cases, the workpiece holder includes multiple blades which engage the end of the workpiece. In these applications, it is necessary to measure the cross-section of the workpiece in order to determine the center of the cross-section of the workpiece so that the workpiece holder can be engaged with the workpiece such that the center of rotation of the workpiece holder coincides with the center of the workpiece cross-section.

### SUMMARY OF THE INVENTION

The present disclosure comprises one or more of the features recited in the appended claims and/or the following features which, alone or in any combination, may comprise patentable subject matter:

A workpiece holder comprises a shaft and a receptacle which is secured to the shaft. The shaft may comprise a taper portion, a workpiece-engaging tip, a threaded portion and a flange. The threaded portion may be positioned between the tip and the flange. The flange may be positioned between the threaded portion and the taper portion. In some embodiments, the taper portion may comprise a #2 Morse taper. In other embodiments, the taper portion may comprise other taper configurations such as American National, Brown & Sharpe, or other “self-holding” tapers. In some embodiments, other taper configurations may be utilized which require a positive locking device to prevent slipping.

The receptacle may be embodied as a cup including a base wall and a plurality of sidewalls which intersect one another and the base wall to form a workpiece-receiving cavity having a polygonal cross-section. The side walls may be substantially perpendicular to the base wall. The base wall may include an aperture centered from top to bottom and side to side in the base wall. The aperture may form an internal cylindrical surface including threads sized to be received onto the threaded portion of the shaft such that when the cup is rotationally engaged with the shaft, the cup is secured to the shaft to form the workpiece holder.

The workpiece-engaging tip of the shaft may be received through the aperture of the cup and extend into the cavity of the cup. The cup may be sized such that the interior dimensions of the cavity are configured to receive a workpiece stock of a standard size with minimal clearance between the workpiece stock and the interior of the sidewalls of the cup. Further, the workpiece-engaging tip may be received in the end of the workpiece to engage the workpiece in the workpiece holder. When the workpiece is received within the workpiece holder cavity, the workpiece outer walls may be engaged by the inner walls of the workpiece cavity so that torque from the lathe is transferred through the workpiece holder to the outer surfaces of the workpiece.

Because the workpiece has a polygonal cross-section, the engagement between the inner surfaces of the cavity and the outer surfaces of the workpiece may facilitate the transfer of higher torques to the workpiece. This may thereby increase the rate at which material can be removed from the workpiece.

In some embodiments, the workpiece holder has a square cross-section. In other embodiments, the workpiece holder has a hexagonal cross-section. It should be understood that any of a number of polygonal cross-sections may be employed within scope of the present disclosure. For example, some embodiments may have a triangular cross-section while still other embodiments have a pentagonal or even an octagonal cross-section. In some embodiments, the cross-section may be irregular, such as a rectangle, for example.

In some embodiments, the cup may have any of a number of similarly shaped cross-sections, with varying dimensions so that the cup of the workpiece holder may be replaced when stock of varying sizes is used. In some embodiments, the workpiece holder may comprise a shaft and a number of cups having varying sizes and shapes so that a user may select the appropriate cup to be employed in a particular application. Therefore, any of a number of sizes and shapes of a workpiece may be received by the various cups of the workpiece holder.

A method of configuring the workpiece holder may comprise selecting a first workpiece having a first cross-sectional shape, selecting a first receptacle configured to receive the first workpiece, securing the first receptacle to the shaft, and securing the shaft to the lathe. The first workpiece may be inserted into the first receptacle. The workpiece holder may be reconfigured by removing the workpiece from the receptacle, removing the first receptacle from the shaft while the shaft is secured to the lathe, selecting a second workpiece have a second cross-sectional shape, and securing a second receptacle configured to receive the second workpiece to the shaft. The second workpiece may be inserted into the second receptacle. In some embodiments, the first workpiece may be worked on while the first workpiece is inserted into the first receptacle. Also, the second workpiece may be worked on while the second workpiece is inserted into the first receptacle.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is an exploded side view of an embodiment of the workpiece holder of the present disclosure, the workpiece holder including a cup and a shaft;

FIG. 2 is an end view of the cup of the workpiece holder of FIG. 1, the cup having a square cross-section;

FIG. 3 is an end view of the another cup similar to the cup shown in FIG. 2, but having a different size to receive a workpiece having different cross-sectional dimensions;

FIG. 4 is an end view of yet another cup similar to the cups of FIGS. 2 and 3, the cup having still yet another size; and

FIG. 5 is an end view of yet still another cup having a hexagonal cross-section.

### DETAILED DESCRIPTION OF THE DRAWINGS

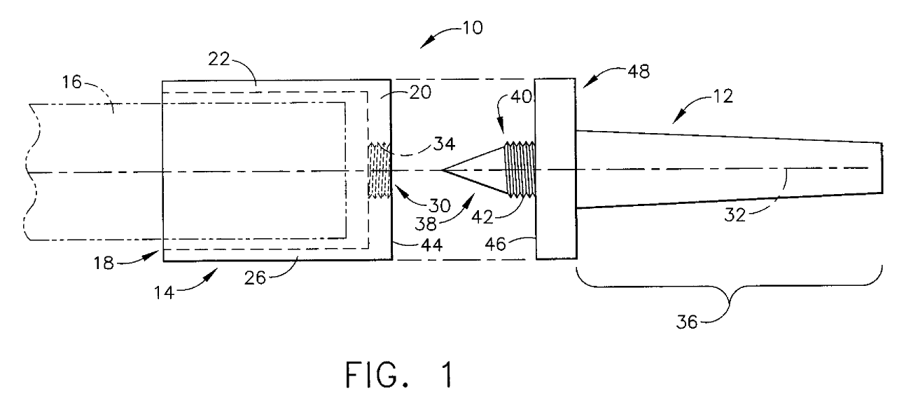

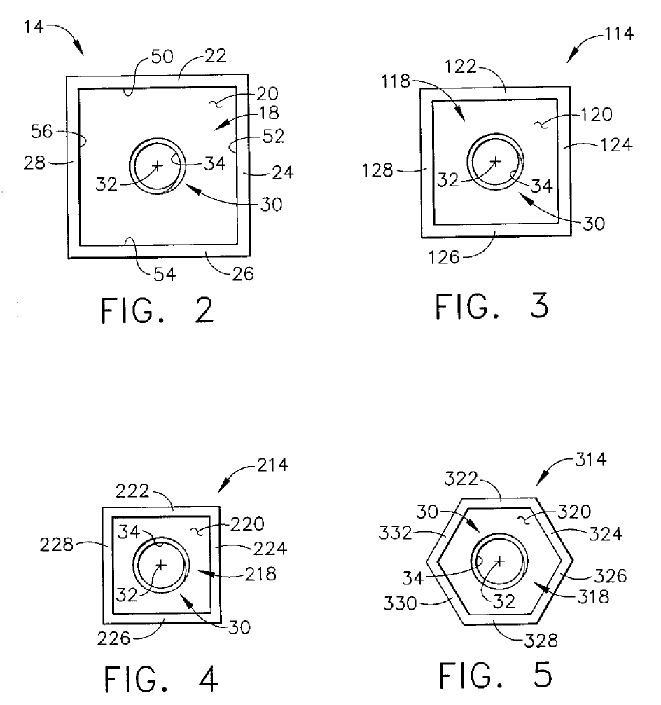

A workpiece holder 10 comprises a shaft 12 and a receptacle illustratively embodied as a cup 14 as shown in FIG. 1. The illustrative cup 14 is configured to receive a workpiece 16 in a cavity 18 of cup 14. Cup 14 includes a base wall 20 and four sidewalls 22, 24, 26, 28. Each of sidewalls 22, 24, 26, 28 intersect base wall 20 and at least two other sidewalls 22, 24, 26, 28 such that when the cup 14 is viewed from an end, sidewalls 22, 24, 26, 28 form a square. The sidewalls 22, 24, 26, 28 are each substantially perpendicular to the base wall 20. Cavity 18 is defined by the base wall 20 and sidewalls 22, 24, 26, 28. Referring now to FIG. 2, it can be seen that the base wall 20 has an aperture 30 formed a therethrough. Aperture 30 is centered on an axis 32 which coincides with a center of rotation of a lathe (not shown) when a workpiece holder 10 is secured in a chuck of a lathe. Aperture 30 defines an internal cylindrical surface 34 which has female threads (not shown) formed therein.

Referring again to FIG. 1, shaft 12 includes a tapered portion 36 which is illustratively configured as a #2 Morse taper. Tapered portion 36 is configured to be received in a chuck of a lathe. While the illustrative embodiment of FIG. 1 is shown as a #2 Morse taper, it should be understood that any of a number of taper configurations may be employed such as American National, Brown & Sharpe, or other “self-holding” tapers. In some embodiments, other taper configurations may be utilized which require a positive locking device to prevent slipping.

Shaft 12 also includes a workpiece engagement tip 38 formed in the end of shaft 12 opposite tapered portion 36. Tip 38 is configured to pass through aperture 30 and extend into cavity 18 when cup 14 is secured to shaft 12. A surface 40 is positioned adjacent to tip 38 along shaft 12. Surface 40 includes male threads 42 formed in surface 40 and configured to engage with the female threads of cylindrical surface 34 of aperture 30. When cup 14 is engaged with shaft 12, cup 14 is rotated about axis 32 so that threads 42 engage with the threads of cylindrical surface 34. Side wall 20 of cup 14 includes a surface 44 which engages a surface 46 of shaft 12 when cup 14 is fully engaged with shaft 12. Surface 46 is part of an annular flange 48 which is adjacent to surface 40 along the length of shaft 12. The engagement of surface 44 with surface 46 and the engagement of threads 42 with the threads of cylindrical surface 34 results in a frictional locking of cup 14 to shaft 12 such that cup 14 and shaft 12 form workpiece holder 10 and rotate together about axis 32.

Workpiece 16 is received within cavity 18 such that the external surfaces of workpiece 16 engage four inner surfaces 50, 52, 54, 56 of side walls 22, 24, 26, 28 of cup 14 respectively. The engagement of the external surfaces of workpiece 16 with the inner surfaces 50, 52, 54, 56 provides minimal clearance between the workpiece 16 and inner surfaces 50, 52, 54, 56 allowing the workpiece 16 to be secured within cup 14. Such engagement between the inner surfaces of the cup 14 and the outer surfaces of the workpiece 16 may operate to permit torque, which is transferred from the lathe through shaft 12 and cup 14 to the workpiece 16, to be transferred and distributed over the external surfaces of workpiece 16 thereby allowing the lathe to operate at higher speeds. Accordingly, a user may be able to remove material from workpiece 16 at higher speeds than the speeds that are typically used on a wood turning lathe, for example.

Referring now to FIG. 3, another embodiment of a cup 114 includes a base wall 120 and side walls 122, 124, 126, 128. The sidewalls 122, 124, 126, 128 are each substantially perpendicular to the base wall 120. Side walls 122, 124, 126, 128 and base wall 120 define a cavity 118 similar to cavity 18 of cup 14. Aperture 30 is formed in base wall 120 similar to the configuration of cup 14. This permits cup 114 to be engaged with shaft 12 to form a workpiece holder configured to receive a workpiece having a square cross-section with dimensions smaller than workpiece 16 shown in FIG. 1. For example, cup 14 may be configured to receive a standard 2.5″×2.5″ piece of wood stock and cup 114 may be configured to receive a standard 1.5″×1.5″ piece of wood stock.

Yet another embodiment of a cup 214 is shown in FIG. 4. Cup 214 includes a base wall 220 and side walls 222, 224, 226, 228. The sidewalls 222, 224, 226, 228 are each substantially perpendicular to the base wall 220. Side walls 222, 224, 226, 228 form a cavity 218 which is sized to receive a square workpiece having yet smaller dimensions then the size of a workpiece to be received in cavity 118 of cup 114. As with the cups 14 and 114, cup 214 is configured to be secured with shaft 12 to form a workpiece holder. Thus, multiple cups may be used with a single shaft 12 to configure a workpiece holder 10 to be adapted for a particular size of workpiece 16. This permits a user to reconfigure the workpiece holder 10 depending on the size of workpiece stock to be machined without the need to remove the shaft of the workpiece holder 10.

The cups 14, 114, 214 of the illustrative embodiments of FIGS. 1-4 are shown with cavities which have a square cross-section when viewed along axis 32. However, it should be understood that any of a number of polygonal shapes may be utilized within the spirit of the disclosure. For example, a cup 314 has a hexagonal cross-section when viewed along axis 32 as shown in FIG. 5. Cup 314 includes a base wall 320 and side walls 322, 324, 326, 328, 330, 332. Side walls 322, 324, 326, 328, 330, 332 intersect base wall 320 and form a hexagonal cavity 318 configured to receive a workpiece having a hexagonal cross-section. Cup 314 includes aperture 30 with cylindrical surface 34 having female threads formed in surface 34 to be engaged with threads 42 of shaft 12 so that cup 314 may engage shaft 12 to form yet another configuration of workpiece holder.

It should be understood that in addition to the square cross-section configuration of cups 14, 114, 214 and hexagonal cross-section of cup 314, any of a number of sizes and cross-sectional shapes of cup may be used within the spirit of the disclosure to form a workpiece holder by removably securing the cup to shaft 12. Thus, workpiece holder 10 may be configurable for various applications.

Although certain illustrative embodiments have been described in detail above, variations and modifications exist within the scope and spirit of this disclosure as described and as defined in the following claims.

1. A workpiece holder for a lathe comprising:
a shaft having (i) a taper portion configured to be received in a chuck of the lathe, (ii) a tip configured to engage a workpiece, (iii) a threaded portion and (iv) a flange, the threaded portion positioned between the tip and the flange and the flange positioned between the threaded portion and the taper portion; and
a receptacle configured to be removably secured to the shaft, the receptacle having a plurality of side walls engaging a base wall to form a workpiece-receiving cavity.

2. The workpiece holder of claim 1, wherein the longitudinal axis of the shaft defines an axis of rotation about which the workpiece holder is configured to rotate.

3. The workpiece holder of claim 1, wherein the each of the sidewalls are substantially perpendicular to the base wall.

4. The workpiece holder of claim 1, wherein the workpiece-receiving cavity has a hexagonal cross-section when viewed along an axis generally perpendicular to the base wall of the receptacle.

5. The workpiece holder of claim 1, wherein the workpiece-receiving cavity has a square cross-section when viewed along an axis generally perpendicular to the base wall of the receptacle.

6. The workpiece holder of claim 1, wherein the receptacle includes an aperture centered in the base wall of the receptacle.

7. The workpiece holder of claim 6, wherein the aperture is threaded and is configured to receive the threaded portion of the shaft.

8. The workpiece holder of claim 1, wherein the flange includes a surface adjacent the threaded portion and the base wall of the receptacle includes an exterior surface engaged with the surface of the flange when the receptacle is secured to the shaft.

9. A workpiece holder system comprising:
a shaft having (i) a taper portion configured to be received in a chuck of the lathe, (ii) a tip configured to engage a workpiece, (iii) a threaded portion and (iv) a flange, the threaded portion positioned between the tip and the flange and the flange positioned between the threaded portion and the taper portion;
a first receptacle configured to be removably secured to the shaft, the first receptacle having a plurality of side walls engaging a base wall to form a first workpiece-receiving cavity; and
a second receptacle configured to be removably secured to the shaft, the second receptacle having a plurality of side walls engaging a base wall to form a second workpiece-receiving cavity, the second workpiece-receiving cavity having a second cross-sectional shape when viewed along an axis generally perpendicular to the base wall of the second receptacle that is different than a cross-sectional of the first receptacle when viewed along an axis generally perpendicular to the base wall of the first receptacle.

10. The workpiece holder system of claim 9, wherein the first and second workpiece-receiving cavities are each configured to receive a standard size piece of workpiece stock.

11. The workpiece holder system of claim 9, wherein the first receptacle and the second receptacle each includes an aperture centered in the base wall of the receptacle.

12. The workpiece holder system of claim 11, wherein the aperture of each of the first and second receptacles is threaded and is configured to receive the threaded portion of the shaft.

13. The workpiece holder system of claim 9, wherein the flange includes a surface adjacent the threaded portion and the base wall of each of the first and second receptacles includes an exterior surface which is configured to engage the surface of the flange when the respective one of the first and second receptacles is secured to the shaft.

14. The workpiece holder system of claim 9, further comprising a third receptacle configured to be removably secured to the shaft, the third receptacle having a plurality of side walls engaging a base wall to form a third workpiece-receiving cavity, the workpiece-receiving cavity of the third receptacle having a third cross-sectional shape when viewed along an axis generally perpendicular to the base wall of the third receptacle that is different than the first and second cross-sectional shapes.

15. The workpiece holder system of claim 9, wherein the first cross-sectional shape is square.

16. The workpiece holder system of claim 15, wherein the second cross-sectional shape is hexagonal.

17. The workpiece holder system of claim 15, wherein the second cross-sectional shape is square.

18. A method of configuring a workpiece holder for a lathe, the workpiece holder comprising (i) a shaft configured to be received in a chuck of the lathe, and (ii) a plurality of receptacles configured to be removably secured to the shaft, each receptacle having a plurality of side walls engaging a base wall to form a workpiece-receiving cavity, the method comprising
selecting a first workpiece having a first cross-sectional shape,
selecting a first receptacle configured to receive the first workpiece,
securing the first receptacle to the shaft,
securing the shaft to the lathe,
inserting the first workpiece into the first receptacle,
removing the workpiece from the receptacle,
removing the first receptacle from the shaft while the shaft is secured to the lathe,
selecting a second workpiece have a second cross-sectional shape,
securing a second receptacle configured to receive the second workpiece to the shaft, and
inserting the second workpiece into the second receptacle.

19. The method of claim 18, further comprising performing work on the first workpiece while the first workpiece is inserted into the first receptacle.

20. The method of claim 19, further comprising performing work on the second workpiece while the second workpiece is inserted into the second receptacle.
